(19) United States
(12) Patent Application Publication
(10) Pub. No.: US 2024/0076451 A1
(43) Pub. Date: Mar. 7, 2024

(54) BLACK MATTE POLYIMIDE FILM

(71) Applicant: TAIMIDE TECHNOLOGY INCORPORATION, Hsinchu Hsien (TW)

(72) Inventors: YUNG-CHU CHUANG, Hsinchu Hsien (TW); YI-HSUEH HO, Hsinchu Hsien (TW); TING-XUAN DENG, Hsinchu Hsien (TW)

(21) Appl. No.: 18/457,370

(22) Filed: Aug. 29, 2023

(30) Foreign Application Priority Data
Sep. 2, 2022 (TW) 111133357

(51) Int. Cl. C08G 73/10; C08K 3/04; C08K 5/18; C08K 7/26

(52) U.S. Cl. CPC C08G 73/1067; C08G 73/1032; C08K 3/04; C08K 5/18; C08K 7/26; C08J 2379/08

(57) ABSTRACT

Provide a black matte polyimide film, including polyimide in an amount from 87 to 97 wt % of the black matte polyimide film, in which aromatic dianhydride and aromatic diamine are polymerized to form a polyimide precursor, and the polyimide precursor is chemically cyclized to form the polyimide, wherein the aromatic dianhydride at least includes 3,3′,4,4′-biphenyltetracarboxylic dianhydride in an amount being no less than 20 mol % of the aromatic dianhydride, and the aromatic diamine at least includes p-phenylenediamine in an amount from 5 to 40 mol % of the aromatic diamine; carbon black in an amount from 2 to 8 wt % of the black matte polyimide film; and silicon dioxide powder having a particle size between 1 and 10 μm and a density less than 1 g/cm³ and being in an amount from 1 to 5 wt % of the polyimide film.

### CROSS-REFERENCE TO RELATED APPLICATION

This non-provisional application claims priority under 35 U.S.C. § 119(a) on Patent Application No(s). 111133357 filed in Taiwan, R.O.C. on Sep. 2, 2022, the entire contents of which are hereby incorporated by reference.

### BACKGROUND OF THE INVENTION

### 1. Field of the Invention

The present disclosure relates to a black matte polyimide film, and more particularly to a black matte polyimide film having silicon dioxide powder with a density of less than 1 g/cm³ added therein, and the black matte polyimide film has a gloss less than 60 and a dielectric dissipation factor less than 0.045 at 10 GHz.

### 2. Description of the Related Art

A polyimide film is generally used in a cover layer of a flexible circuit board, and a black matte polyimide film is generally used in a flexible board due to its special optical properties.

In recent years, with the high performance and high functionality of electronic equipment, cover layers need to have electrical insulation properties at high frequencies are required, and also maintain acceptable structural and optical properties to provide protection for electronic components and avoid unnecessary visual inspection and damage.

The conventional black matt polyimide film mainly uses carbon black as a pigment, dyeing agent, etc. to reduce its light transmittance, thereby achieving covering and protecting functions. A colored polyimide films causes a large amount of reflected light on its surface, and thus a matting agent is added to reduce the visual discomfort caused by the reflection of the film.

However, due to the electrical characteristics of carbon black, the dielectric dissipation factor (Df) of the film is likely to increase, so as to cause noise or delay in electronic communication transmission, such that the difficulty of realizing a low-dielectric black matte polyimide film is increased.

U.S. Pat. No. 8,440,315B2 discloses a black matt polyimide film using silicon dioxide as a matting agent. Silicon dioxide is an inorganic compound with high dielectric coefficient (Dk), dielectric dissipation factor (Df) and high density, and has a smaller volume than other components while being added, such that silicon dioxide needs to be added in a certain amount in order to achieve the effect of low gloss. This may cause defects such as holes on the film, and also affect the mechanical properties of the film.

U.S. Ser. No. 10/336,045B2 discloses a base film prepared by using pyromellitic dianhydride, 4,4′-diaminodiphenyl ether and p-phenylenediamine. The base film has a low thermal expansion coefficient; however, when the proportion of pyromellitic dianhydride it is high, the base film would absorb moisture in the air to adversely affects the electrical properties, such that this base film cannot be used in high-frequency communication.

In order to overcome the above drawbacks, the present disclosure provides a black matte polyimide film having great electrical properties and maintaining low gloss.

### BRIEF SUMMARY OF THE INVENTION

The black matte polyimide film of the present disclosure includes polyimide in an amount from 87 to 97 wt % of the black matte polyimide film, in which aromatic dianhydride and aromatic diamine are polymerized to form a polyimide precursor, and the polyimide precursor is chemically cyclized to form the polyimide, wherein the aromatic dianhydride at least includes 3,3′,4,4′-biphenyltetracarboxylic dianhydride (BPDA) in an amount being no less than 20 mol % of the aromatic dianhydride, and the aromatic diamine at least includes p-phenylenediamine in an amount from 5 to 40 mol % of the aromatic diamine; carbon black in an amount from 2 to 8 wt % of the black matte polyimide film; and silicon dioxide powder having a particle size between 1 and 10 μm and a density less than 1 g/cm³ and being in an amount from 1 to 5 wt % of the polyimide film, wherein the black matte polyimide film has a gloss value at 600 being less than 60 and a dielectric dissipation factor being less than 0.045 at 10 GHz.

### DETAILED DESCRIPTION OF THE INVENTION

The polyimide precursor (polyamic acid), silicon dioxide powder and carbon black are required in the preparation of the black matte polyimide film. The silicon dioxide powder and the carbon black are respectively prepared into a matte slurry and a carbon black slurry, which are then mixed with the polyimide precursor, and the polyimide precursor is cyclized into polyimide through a chemical cyclization process.

Preparation of Polyimide Precursor

The polyimide precursor is made of aromatic dianhydride and aromatic diamine.

The aromatic dianhydride at least include 3,3′,4,4′-biphenyltetracarboxylic dianhydride (BPDA), and 3,3′,4,4′-biphenyltetracarboxylic dianhydride (BPDA) is in an amount no less than 20 mol % of the aromatic dianhydride.

The aromatic diamine at least includes p-phenylenediamine (PDA), and p-phenylenediamine (PDA) is in an amount from 5 to 40 mol % of the aromatic diamine.

In the preparation of the polyimide precursor, dimethylacetamide (DMAc), N-methylpyrrolidone (NMP), N-ethyl-2-pyrrolidone (NEP), γ-butyrolactone (GBL), or N,N-dimethylformamide (DMF) can be used as the solvent. In this embodiment, dimethylacetamide (DMAc) is used as the solvent.

Preparation of Carbon Black Slurry

The carbon black and dimethylacetamide are mixed in a weight ratio of 1:7 to form a solution, and stirred well. Then, the solution is vibrated at 43 KHz for 1 hour with an ultrasonic oscillator to form the carbon black slurry.

The carbon black in the carbon black slurry is insulating carbon black.

The weight ratio of carbon black and dimethylacetamide in the carbon black slurry can be adjusted as required. The weight ratio of carbon black is related to transmittance and dielectric dissipation factor. If the proportion of carbon black is too high, the dielectric dissipation factor will increase. In the present disclosure, the carbon black is in an amount from 2 to 8 wt % of the black matte polyimide film.

Preparation of Matte Slurry

The silicon dioxide powder, a dispersant and dimethylacetamide are provided to form a solution in a weight ratio of 1:0.05:19. The solution is vibrated at 43 KHz for 2 hours with an ultrasonic oscillator to form the matte slurry.

In the matte slurry, the silicon dioxide powder is hollow, and has a density less than 1 g/cm³.

In the matte slurry, the silicon dioxide powder has a particle size between 1 and 10 μm.

The weight ratio of silicon dioxide powder, dispersant and dimethylacetamide in the matte slurry can be adjusted as required. The weight ratio of silicon dioxide powder is related to gloss and dielectric dissipation factor. If the proportion of silicon dioxide powder is too small, the gloss and dielectric dissipation factor of the black matte polyimide film will increase, resulting in difficult visual inspection of the finished product and increased transmission loss.

Preparation of Black Matte Polyimide Film

The carbon black slurry, the matte slurry and the polyimide precursor are mixed and stirred evenly, and then a catalyst and a dehydrating agent are added for chemical cyclization. The dehydrating agent can be acetic anhydride or benzoic anhydride. In the present disclosure, acetic anhydride is used as the dehydrating agent, and the catalyst can be pyridine, 3-methylpyridine, 2-methylpyridine, 4-methylpyridine, isoquinoline, quinoline and triethylamine, wherein the preferred catalysts are pyridine, 3-methylpyridine, 2-methylpyridine and 4-methylpyridine. In the present disclosure, 3-methylpyridine is used as the catalyst.

The catalyzer and the dehydrating agent can be used alone, or can be mixed and diluted with the solvent. After being stirred evenly, the mixed solution of the catalyzer and the dehydrating agent is defoamed by a centrifugal defoaming machine. The defoamed solution is coated on a glass plate by a blade with a gap of 900 μm. After being applied to the glass plate, the coated sample is placed in an oven at 80° C. for 20 minutes, heated to 170° C. for 20 minutes, and then heated to 350° C. for 20 minutes as the final treatment. Then, the glass plate is placed in water, and the film is removed to obtain a black matte polyimide film.

In addition to the glass plate, a metal plate can be used in the above preparation. In the case that a metal plate is used in the preparation of a black matte polyimide film, after the coated sample is baked and dried in an oven at 80° C., the semi-dry film needs to be removed from the metal plate. The semi-dry film is fixed on a metal frame, heated to 170° C. for 20 minutes, and then heated to 350° C. for 20 minutes, such that a black matte polyimide film is obtained.

The black matte polyimide film has a thickness of 5 μm to 100 μm.

The black matte polyimide film can be used as a cover film, which has an adhesive layer and a base film.

### EXAMPLES

Hereinafter, the present disclosure will be specifically described based on examples, but the present disclosure is not limited thereto. In addition, the detail of the raw material shown by the abbreviation in each Example is presented below.
raw material of polyimide
PMDA: pyromellitic dianhydride
BPDA: 3,3′,4,4′-biphenyltetracarboxylic dianhydride
PDA: p-phenylenediamine
ODA: 4,4′-oxydianiline
raw material of matte slurry
   high density silicon dioxide powder: SFP-30MHE, density of 2.2 g/cm³, manufactured by Denka Company Limited
   low density silicon dioxide powder: Cell Spheres-NF, density of 0.63 g/cm³, manufactured by Taiheiyo Cement Corporation

Raw Material of Carbon Black Slurry

carbon black: SPECIAL BLACK 4A (SB4A), manufactured by Taiheiyo Cement Corporation Evonik Industries AG
dispersant
   dispersant: BYK-180, manufactured by BYK Chemie GmbH
solvents
   DMAc: dimethylacetamide
   AA: acetic anhydride
   AP: 3-methylpyridine

<Detection Methods>

viscosity of polyamide solution: The measurement is performed with the model DVEELVTJO instrument from BROOK FIELD. The measurement is carried out by pouring the polyamic acid solution into the sample tank of the instrument at 25° C., and waiting for 10 minutes for the data to stabilize, and then recording the value.

Various properties of the composite films obtained in the following examples were measured by the following methods.

Thermal expansion coefficient (100° C.-200° C.): According to ASTM D696 standard, the model Q400 TMA instrument from TA Instruments is used for the measurement. The thermal expansion coefficient of the polyimide film is measured at 100° C. to 200° C., and the heating rate is set to 10° C./min. In order to eliminate the stress caused by the heat treatment, after removing the residual stress by the first measurement, the second measurement result is used as the actual value.

Optical transmittance: According to ISO 14782 standard, the model NDH-2000N instrument from Nippon Denshoku company is used for the measurement.

Gloss: The BYK brand, model micro-TRI-gloss gloss meter is used to measure the gloss at 60 degrees.

dielectric loss tangent Df (10 GHz): The model E5071C ENA Network Analyzer instrument from Keysight Technologies is used for the measurement. The measurement is carried out by baking the polymer film in an oven at 120° C. for 30 minutes, then taking it out, placing it in an environment with a humidity of 65%, and measuring it after standing for 48 hours.

### Example 1

Preparation of Carbon Black Slurry

1 g of carbon black and 7 g of DMAc were placed into a solution, stirred evenly, and oscillated at 43 KHz for 1 hour with an ultrasonic oscillator to form the carbon black slurry.

Preparation of Low Density Matte Slurry

0.5 g of low density silicon dioxide powder, 0.025 g of the dispersant and 9.5 g of DMAc were placed into a solution, stirred evenly, and oscillated at 43 KHz for 2 hours with an ultrasonic oscillator to form the matte slurry.

Preparation of Polyimide Precursor

8.909 g of PDA was added in 467.5 g of DMAc to form a mixture, and the mixture was stirred. After PDA was completely dissolved, 15.15 g of BPDA was added and stirred, and the reaction was carried out for 60 minutes. Then, 24.746 g of ODA was added and dissolved, then 32.021 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 255,600 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.21 ml of the diluted AA solution and 3.54 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Example 2

The preparation of carbon black slurry was the same as that in Example 1.

The preparation of low density matte slurry was the same as that in Example 1.

The preparation of polyimide precursor was the same as that in Example 1.

Preparation of Black Matte Polyimide Film

1.918 g of the carbon black slurry, 4.7948 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.21 ml of the diluted AA solution and 3.54 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Example 3

The preparation of carbon black slurry was the same as that in Example 1.

The preparation of low density matte slurry was the same as that in Example 1.

Preparation of Polyimide Precursor

6.532 g of PDA was added in 467.5 g of DMAc to form a mixture, and the mixture was stirred. After PDA was completely dissolved, 14.810 g of BPDA was added and stirred, and the reaction was carried out for 60 minutes. Then, 28.221 g of ODA was added and dissolved, then 32.278 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 223,400 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.10 ml of the diluted AA solution and 3.46 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Example 4

The preparation of carbon black slurry was the same as that in Example 1.

The preparation of low density matte slurry was the same as that in Example 1.

Preparation of Polyimide Precursor

8.067 g of PDA was added in 467.5 g of DMAc to form a mixture, and the mixture was stirred. After PDA was completely dissolved, 43.894 g of BPDA was added and stirred, and the reaction was carried out for 60 minutes. Then, 22.405 g of ODA was added and dissolved, then 7.525 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 223,000 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 4.72 ml of the diluted AA solution and 3.20 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Example 5

The preparation of carbon black slurry was the same as that in Example 1.

The preparation of low density matte slurry was the same as that in Example 1.

Preparation of Polyimide Precursor

3.748 g of PDA was added in 467.5 g of DMAc to form a mixture, and the mixture was stirred. After PDA was completely dissolved, 6.374 g of BPDA was added and stirred, and the reaction was carried out for 60 minutes. Then, 27.762 g of ODA was added and dissolved, then 43.851 g of BPDA was slowly added, and the temperature was kept at 25° C. After the reaction was carried out for two hours, a trace amount of BPDA was gradually used to adjust the viscosity to form a polyamic acid solution with a solid content of 15% and a viscosity of 242,000 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 4.39 ml of the diluted AA solution and 2.97 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Comparative Example 1

The preparation of carbon black slurry was the same as that in Example 1.

The preparation of low density matte slurry was the same as that in Example 1.

Preparation of Polyimide Precursor

39.487 g of ODA was added in 467.5 g of DMAc to form a mixture, and the mixture was stirred. After ODA was completely dissolved, 42.368 g of PMDA was added, and the temperature was kept at 25° C. After the reaction was carried out for two hours, a trace amount of PMDA was gradually used to adjust the viscosity to form a polyamic acid solution with a solid content of 15% and a viscosity of 246,000 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 4.99 ml of the diluted AA solution and 3.38 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Comparative Example 2

The preparation of carbon black slurry was the same as that in Example 1.

The preparation of low density matte slurry was the same as that in Example 1.

Preparation of Polyimide Precursor

8.087 g of PDA was added in 467.5 g of DMAc to form a mixture, and the mixture was stirred. After PDA was completely dissolved, 13.049 g of PMDA was added, and the reaction was carried out for 60 minutes. Then, 27.809 g of ODA was added and dissolved, then 32.856 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 240,000 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.41 ml of the diluted AA solution and 3.67 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Comparative Example 3

The preparation of carbon black slurry was the same as that in Example 1.

Preparation of High Density Matte Slurry

3 g of high density silicon dioxide powder, 0.5 g of the dispersant and 27 g of DMAc were placed into a solution, stirred and mixed evenly. The solution was ground with 0.5 mm zirconium beads for 2 hours with a zirconium bead filling rate of 14% by volume to form the high density matte slurry.

The preparation of polyimide precursor was the same as that in Example 1.

Preparation of Black Matte Polyimide Film

1.879 g of the carbon black slurry, 1.1429 g of the high density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.21 ml of the diluted AA solution and 3.54 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Comparative Example 4

The preparation of carbon black slurry was the same as that in Example 1.

The preparation of low density matte slurry was the same as that in Example 1.

Preparation of Polyimide Precursor

9.171 g of PDA was added in 467.5 g of DMAc to form a mixture, and the mixture was stirred. After PDA was completely dissolved, 6.238 g of BPDA was added, and the reaction was carried out for 60 minutes. Then, 25.472 g of ODA was added and dissolved, then 40.926 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 287,200 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 5.37 ml of the diluted AA solution and 3.64 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

### Comparative Example 5

The preparation of carbon black slurry was the same as that in Example 1.

The preparation of low density matte slurry was the same as that in Example 1.

Preparation of Polyimide Precursor

23.404 g of PDA was added in 467.5 g of DMAc to form a mixture, and the mixture was stirred. After PDA was completely dissolved, 7.075 g of BPDA was added, and the reaction was carried out for 60 minutes. Then, 4.815 g of ODA was added and dissolved, then 46.419 g of PMDA was slowly added, and the temperature was kept at 25° C. After the reaction was carried out for two hours, a trace amount of PMDA was gradually used to adjust the viscosity to form a polyamic acid solution with a solid content of 15% and a viscosity of 263,000 cps at 25° C.

Preparation of Black Matte Polyimide Film

1.879 g of the carbon black slurry, 2.2857 g of the low density matte slurry, 40 g of the polyamic acid solution and 20 g of DMAc were placed to form a mixture and stirred evenly. Then, AA was diluted with DMAc in a weight ratio of 5 to 1, and AP was diluted with DMAc in a weight ratio of 1 to 1 to form a diluted AA solution and a diluted AP solution, respectively. Then, 6.09 ml of the diluted AA solution and 4.13 ml of the diluted AP solution were added to the mixture to form a mixed solution. After being stirred and mixed evenly, the mixed solution was defoamed by a centrifugal defoaming machine. The defoamed solution was coated on the glass plate by a blade with a gap of 900 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The glass substrate was immersed in water, and the black matte polyimide film was peeled off from the glass substrate. The thickness of the film was 25 μm.

The following table shows the comparison between Examples and Comparative Examples.

TABLE 1

| | | | | | Carbon | | | | | | | | |
|---|---|---|---|---|---|---|---|---|---|---|---|---|---|
| | | | | | black | Silicon dioxide | | Silicon dioxide | | | | | |
| | | | | | CB | SFP-30MHE | | CellSpheres-NF | | | | | |
| | dianhydride | | diamine | | amount | amount | density | amount | density | TT | Gloss | Df | CTE |
| | mo1 % | | moł % | | wt % | wt % | g/cm³ | wt % | g/cm³ | % | GU | 10 GHz | ppm/° C. |
| Example 1 | PMDA | BPDA | PDA | ODA | 4 | — | — | 2 | 0.63 | 0 | 34 | 0.037 | 21 |
| | 75 | 25 | 40 | 60 | | | | | | | | | |
| Example 2 | PMDA | BPDA | PDA | ODA | 4 | — | — | 4 | 0.63 | 0 | 17 | 0.041 | 20 |
| | 75 | 25 | 40 | 60 | | | | | | | | | |
| Example 3 | PMDA | BPDA | PDA | ODA | 4 | — | — | 2 | 0.63 | 0 | 43 | 0.036 | 23 |
| | 75 | 25 | 30 | 70 | | | | | | | | | |
| Example 4 | PMDA | BPDA | PDA | ODA | 4 | — | — | 2 | 0.63 | 0 | 40 | 0.031 | 33 |
| | 20 | 80 | 40 | 60 | | | | | | | | | |
| Example 5 | PMDA | BPDA | PDA | ODA | 4 | — | — | 2 | 0.63 | 0 | 53 | 0.019 | 43 |
| | — | 100 | 20 | 80 | | | | | | | | | |
| Comparative | PMDA | BPDA | PDA | ODA | 4 | — | — | 2 | 0.63 | 0 | 42 | 0.049 | 34 |
| Example 1 | 100 | — | — | 100 | | | | | | | | | |
| Comparative | PMDA | BPDA | PDA | ODA | 4 | — | — | 2 | 0.63 | 0 | 37 | 0.050 | 13 |
| Example 2 | 100 | — | 35 | 65 | | | | | | | | | |
| Comparative | PMDA | BPDA | PDA | ODA | 4 | 2 | 2.2 | — | — | 0 | 100 | 0.044 | 19 |
| Example 3 | 75 | 25 | 40 | 60 | | | | | | | | | |
| Comparative | PMDA | BPDA | PDA | ODA | 4 | — | — | 2 | 0.63 | 0 | 44 | 0.047 | 19 |
| Example 4 | 90 | 10 | 40 | 60 | | | | | | | | | |
| Comparative | PMDA | BPDA | PDA | ODA | 4 | — | — | 2 | 0.63 | 0 | 43 | 0.055 | 23 |
| Example 5 | 90 | 10 | 90 | 10 | | | | | | | | | |

As shown in Table 1, in comparison with Comparative Examples, the black matte polyimide films prepared in Examples not only maintain optical properties, but also exhibit lower dielectric dissipation factors.

Since the silicon dioxide powder has lower density, the black matte polyimide films prepared in Examples exhibit the lower dielectric dissipation factors. When the density is smaller, it means that the proportion of air present in the powder is higher, so the dielectric properties of the black matte polyimide film can be reduced. The silicon dioxide power with the lower density has the higher proportion of air present in the particle, such that the dielectric property (dielectric dissipation factor) of the black matte polyimide film is decreased.

Further, the low density silicon dioxide powder also affects the gloss of the film. In addition to the size and the addition ratio of matting particles, the number of particles present on the surface of the film is also very important.

The silicon dioxide powder in Examples has the lower density, such that under the same addition amount, the volume ratio of this powder based on the film is higher, and thus the film exhibits the lower gloss than that in Comparative Examples.

While the present disclosure has been described by means of specific embodiments, numerous modifications and variations could be made thereto by those skilled in the art without departing from the scope and spirit of the present disclosure set forth in the claims.

What is claimed is:

1. A black matte polyimide film, comprising:
polyimide in an amount from 87 to 97 wt % of the black matte polyimide film, in which aromatic dianhydride and aromatic diamine are polymerized to form a polyimide precursor, and the polyimide precursor is chemically cyclized to form the polyimide, wherein the aromatic dianhydride at least includes 3,3′,4,4′-biphenyltetracarboxylic dianhydride (BPDA) in an amount being no less than 20 mol % of the aromatic dianhydride, and the aromatic diamine at least includes p-phenylenediamine in an amount from 5 to 40 mol % of the aromatic diamine;
carbon black in an amount from 2 to 8 wt % of the black matte polyimide film; and
silicon dioxide powder having a particle size between 1 and 10 μm and a density less than 1 g/cm³ and being in an amount from 1 to 5 wt % of the polyimide film,
wherein the black matte polyimide film has a gloss value at 600 being less than 60 and a dielectric dissipation factor being less than 0.045 at 10 GHz.

2. The black matte polyimide film according to claim 1, wherein the polyimide film has a thermal expansion coefficient being less than 35 ppm/° C.

3. The black matte polyimide film according to claim 1, wherein the polyimide film has a thickness between 5 and 100 μm.

4. The black matte polyimide film according to claim 1, wherein the silicon dioxide powder is hollow.
